(19) United States
(12) Patent Application Publication
(10) Pub. No.: US 2018/0329064 A1
(43) Pub. Date: Nov. 15, 2018

(54) METHOD AND APPARATUS FOR MAPPING COLUMN ILLUMINATION TO COLUMN DETECTION IN A TIME OF FLIGHT (TOF) SYSTEM

(71) Applicant: STMicroelectronics (Grenoble 2) SAS, Grenoble (FR)

(72) Inventor: Pascal Mellot, Lans En Vercors (FR)

(73) Assignee: STMicroelectronics (Grenoble 2) SAS, Grenoble (FR)

(21) Appl. No.: 15/590,528

(22) Filed: May 9, 2017

(51) Int. Cl. G01S 17/36; G01B 11/25; G01S 17/06; H04N 5/225; G01S 17/89

(52) U.S. Cl. CPC G01S 17/36; G01B 11/25; G01S 17/89; H04N 5/2256; G01S 17/06

(57) ABSTRACT

A scanning emitter generates a transmit light signal at a first scan position, and a reflection of that transmit light signal is received at a sensor array including columns, wherein each column includes photosensitive pixels. Each photosensitive pixel in the sensor array generates a photo signal in response reception of the reflection of the transmit light signal. Over an evaluation time and for each individual column in the sensor array, a count is made as to the number of times the photosensitive pixels in the column generate photo signals. A light profile histogram is produced from the column counts. The light profile histogram is then processed to detect an optical misalignment between the scanning emitter and the sensor array.

### TECHNICAL FIELD

The present invention relates to time of flight (TOF) systems and, in particular, to the mapping of the illumination column of an emitter array to the detection column of a receiver array.

### BACKGROUND

Time of flight (TOF) systems are well known in the art. Such systems typically operate with an emitter transmitting a light pulse and a receiver detecting a reflection of that light pulse from a target. The difference in time between emission and detection is referred to as the time of flight, and this time difference is correlated to the distance between the system and the target. By scanning a field of illumination (FOI) with emitted light pulses, and by detecting the reflections of those scanned light pulses, a three-dimensional (3D) depth map may be generated from the calculated distances to targets in the FOI.

### SUMMARY

In an embodiment, a circuit comprises: a sensor array including a plurality of columns, wherein each column includes a plurality of photosensitive pixels, each photosensitive pixel configured to generate a photo signal in response to light reception; and a light intensity profile circuit coupled to the sensor array, the light intensity profile circuit comprising a counting circuit for each column storing a count value, wherein the counting circuit is configured to count over an evaluation time a number of times the photosensitive pixels in the column to which the counting circuit is coupled generate photo signals, the count values in the counting circuits after said evaluation providing a light profile histogram.

In an embodiment, a method comprises: generating a transmit light signal at a first scan position; receiving a reflection of said transmit light signal at a sensor array including a plurality of columns, wherein each column includes a plurality of photosensitive pixels; generating by each photosensitive pixel in said sensor array a photo signal in response reception of said reflection; counting, over an evaluation time and for each column in the sensor array, a number of times the photosensitive pixels in the column generate photo signals; and generating from said counting a light profile histogram.

In an embodiment, a scanning emitter generates a transmit light signal at a first scan position, and a reflection of that transmit light signal is received at a sensor array including columns, wherein each column includes photosensitive pixels. Each photosensitive pixel in the sensor array generates a photo signal in response reception of the reflection of the transmit light signal. Over an evaluation time and for each individual column in the sensor array, a count is made as to the number of times the photosensitive pixels in the column generate photo signals. A light profile histogram is produced from the column counts. The light profile histogram is then processed to detect an optical misalignment between the scanning emitter and the sensor array.

### BRIEF DESCRIPTION OF THE DRAWINGS

The accompanying drawings are included to provide a further understanding of the invention and are incorporated in and constitute a part of this specification, illustrate embodiments of the invention and together with the description serve to explain the principles of the invention.

In the drawings:

FIG. 1 shows a block diagram of TOF system;

FIGS. 2 and 3 show examples of the effects of optical misalignment;

FIG. 4 shows a block diagram of TOF system with a light scan position calibration circuit;

FIGS. 5A-5C show circuit diagrams for a light intensity profile circuit;

FIG. 6 illustrates an example of operation of the light intensity profile circuit; and

FIG. 7 schematically shows a portable electronic device includes the TOF system of FIG. 4.

### DETAILED DESCRIPTION

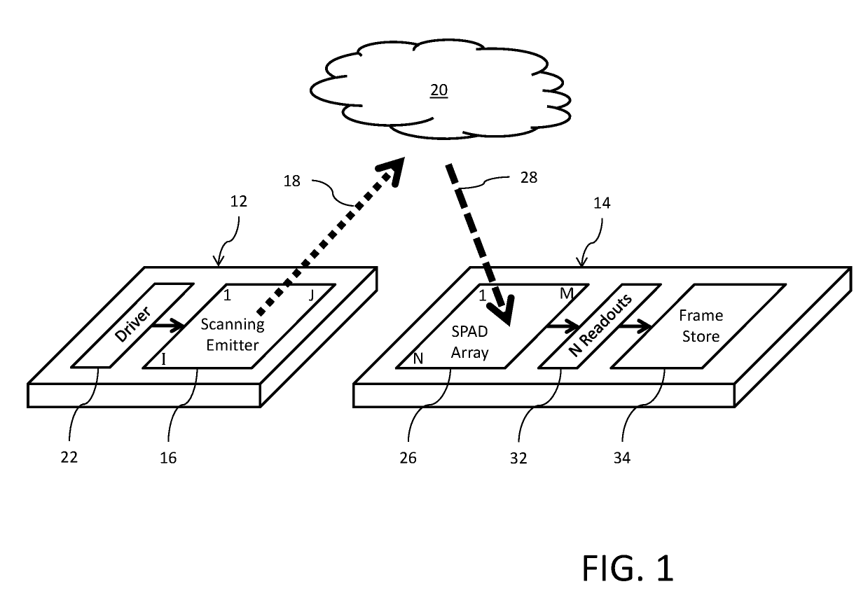

FIG. 1 shows a block diagram of TOF system 10 including an emitter 12 and a receiver 14.

The emitter 12 includes a light scanning emitter 16 to generate a transmit light signal 18 directed to scan a target 20. The light scanning emitter 16 includes a plurality of light emitters arranged in a matrix of rows and columns. Each light emitter may, for example, comprise a vertical-cavity surface-emitting laser (VCSEL) diode. The light scanning emitter 16 may, for example, include I rows of VSCEL diodes arranged in J columns, and thus the light scanning emitter would include I×J VSCEL diodes. In one embodiment J=1, and the scanning operation is accomplished using an oscillating mirror which reflects the light emitted from I VCSEL diodes to scan across the J direction. In another embodiment J>1, and the scanning operation is accomplished by sequentially actuating each of the J columns which include I VSCEL diodes. Although not explicitly shown in FIG. 1, the light scanning emitter 16 may include optical elements (such as one or more lenses) for directing light emitted from the light emitters to form the transmit light signal 18. A driver circuit 22 operates to drive the operation of the light scanning emitter 16 to produce the transmit light signal 18 for scanning the target 20. The driver circuit 22 would control actuation of the VCSEL diodes and, if included, control oscillation of the mirror.

The receiver 14 includes a sensor array 26 formed by a plurality of photosensitive pixels arranged in a matrix of rows and columns. Each photosensitive pixel may, for example, comprise a single photon avalanche diode (SPAD) in which case the sensor array 26 is referred to by those skilled in the art as a SPAD array. The sensor array 26 may, for example, include N rows of photosensitive pixels arranged in M columns, and thus the sensor array would include N×M photosensitive pixels. The sensor array 26 receives a reflected light signal 28 which comprises the transmit light signal 18 as reflected by the target 20 (and may further include light noise). Although not explicitly shown in FIG. 1, the sensor array 26 may include optical elements (such as one or more lenses) for directing light received in the reflected light signal 28 to the photosensitive pixels. Each photosensitive pixel detects light from the reflected light signal 28 to generate a photo signal. The receiver 14 further includes a readout circuit 32 that operates to read the photo signals (for example, a voltage or current value) from the N photosensitive pixels of each of the M columns on a sequential column-by-column basis (i.e., one column at a time). After each individual column readout, the read values of the photo signals are transferred to a frame store circuit 34 which stores the N×M photo signal values in the format of an image frame signal.

There may exist an optical misalignment between the light path for the transmit light signal 18 and the light path for the reflected light signal 28. A possible consequence of such an optical misalignment is that the scan positions for the transmit light signal 18 (and in particular the maxima) will not align with the positions of the M columns of the sensor array 26 (and in particular its maxima).

The forgoing may be better understood by considering a specific, but non-limiting, example. In the context of the FIG. 1 illustration, assume that the scanning of the transmit light signal 18 is horizontal. As a consequence, the reflected light signal 28 will horizontally scan across the M columns of the sensor array 26. In an ideal situation, a left-most maximum position of the horizontal scan of the transmit light signal 18 (for example, column J=first) would produce a reflected light signal 28 received by the sensor array 26 at a corresponding left-most maximum position of the M columns (for example, column M=first). Likewise, a right-most maximum position of the horizontal scan of the transmit light signal 18 (for example, columns J=last) would produce a reflected light signal 28 received by the sensor array 26 at a corresponding right-most maximum position of the M columns (for example, M=last).

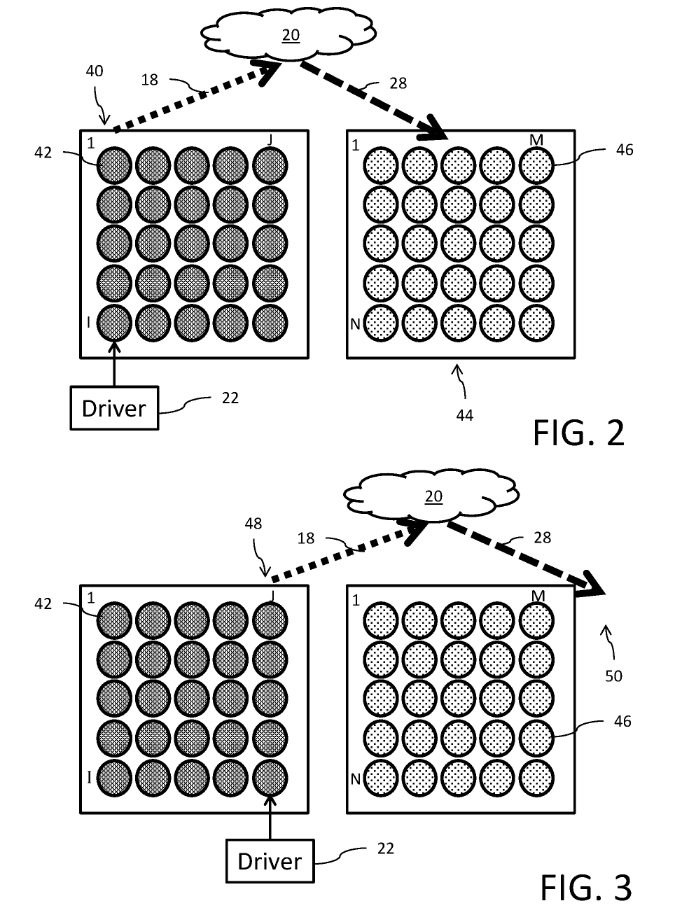

With the optical misalignment, however, the left-most maximum position of the horizontal scan of the transmit light signal 18 (for example, column J=first) may produce a reflected light signal 28 received by the sensor array 26 at a column which is located other than at the left-most maximum position of the M columns (for example, at a column between the maxima, such as, first<M<last). This illustrated in FIG. 2 where a first column (J=first) 40 of VCSEL diodes 42 of the light scanning emitter 16 are actuated by the driver circuit 22 to produce the transmit light signal 18, but the reflected light signal 28 is received by a third column (M=3) 44 of the SPADs 46 of the sensor array 26.

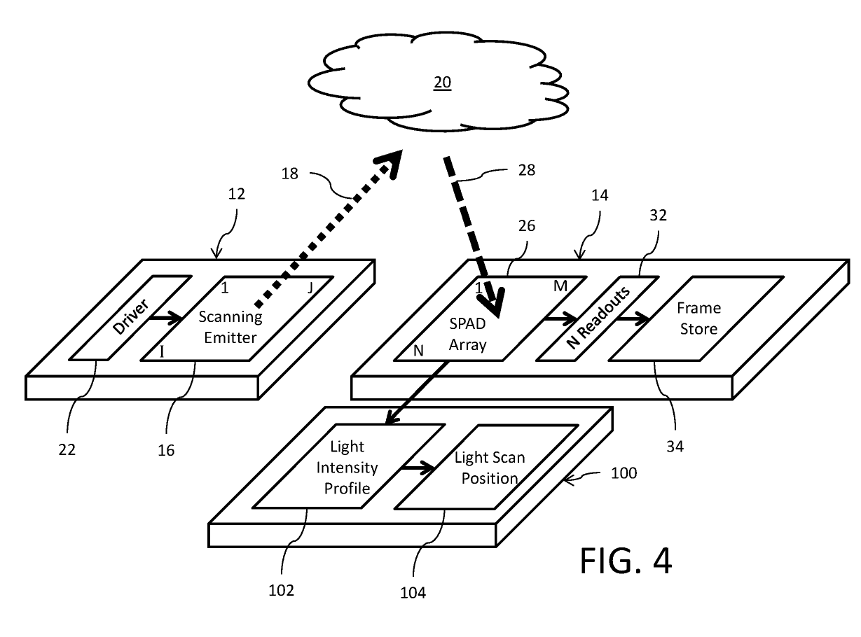

Similarly, the right-most maximum position of the horizontal scan of the transmit light signal 18 (for example, column J=last) may produce a reflected light signal 28 received by the sensor array 26 at a column which is located other than at the right-most maximum of the M columns. As an example, this could be at a location that is not within the sensor array 26, such as, M>last). This illustrated in FIG. 3 where a last column (J=last) 48 of VCSEL diodes 42 of the light scanning emitter 16 are actuated by the driver circuit 22 to produce the transmit light signal 18, but the reflected light signal 28 is received outside 50 of the sensor array (M>last) 26.

The illustration of I=J and M=N in FIGS. 2 and 3 is by example only. Furthermore, the choice of I=J=M=N=5 is also by example only. It will be understood that the integer values for I, K, M and N may be selected as desired for a given TOF sensing application depending on one or more factors including, for example, FOI, processing speed, cost, size, etc.

The illustration of the reflected light signal 28 being received at locations as shown in FIGS. 2 and 3 is also by example only. Any one of a number of combinations of maxima for the transmit light signal 18 and corresponding maxima for the reflected light signal 28 is possible. As one non-limiting example, a left-most and right most maxima for the transmit light signal 18 may result in corresponding reflected light signals both being received outside of the sensor array. Also, in another non-limiting example, a left-most and right most maxima for the transmit light signal 18 may result in corresponding reflected light signals both being received by the sensor array at columns within sensor array but neither at the left-most or right-most column.

It is important, however, for the TOF system to have some knowledge of the effect of the optical misalignment so that correction or adjustment could be made with respect to one or more of: the operation of the light scanning emitter 16, the operation of the sensor array 26 and/or the processing of the photo signal values within the image frame signal.

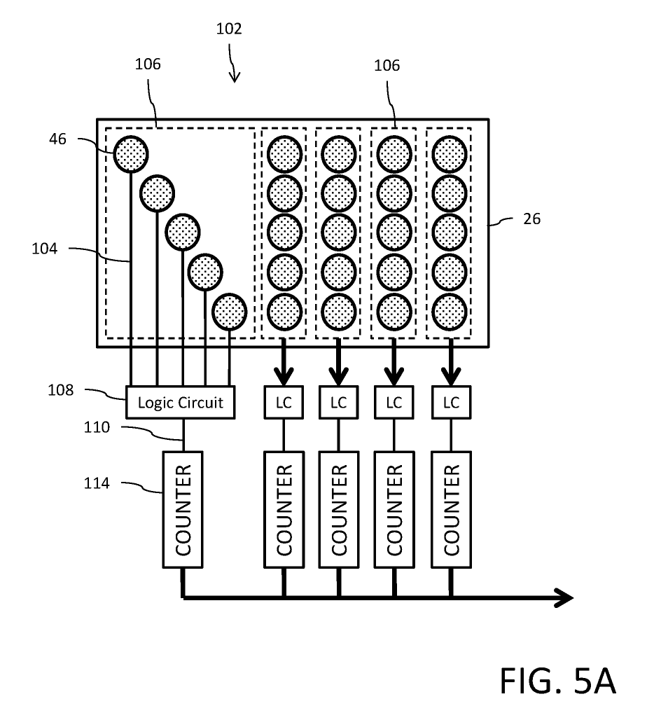

Reference is now made to FIG. 4, wherein like reference numbers refer to like or similar component whose configuration and operation will not be described again. The TOF system in FIG. 4 differs from the TOF system in FIG. 1 in that the system in FIG. 4 further includes a light scan position calibration circuit 100. The circuit 100 includes a light intensity profile circuit 102 and a light scan position circuit 104. The light intensity profile circuit 102 is coupled to receive the photo signals from the photosensitive pixels of the sensor array 26. These photo signals are processed in the light intensity profile circuit 102 on a column by column basis to determine a light intensity value for each column of photosensitive pixels. The column light intensity values are output to the light scan position circuit 104 for processing in order to determine a correlation between the left-most and right most maxima for the transmit light signal 18 and the left-most and right most maxima for the reflected light signal 28. The resulting correlation data is then processed as necessary to correct or adjust for optical misalignment.

In one embodiment, all of the photo signals from the N photosensitive pixels in each column are processed to determine the column light intensity value. In another embodiment, a subset of the N photosensitive pixels in each column is processed to determine the column light intensity value. For example, the subset may comprise every other photosensitive pixel or every third or fourth photosensitive pixel (for example) in the column.

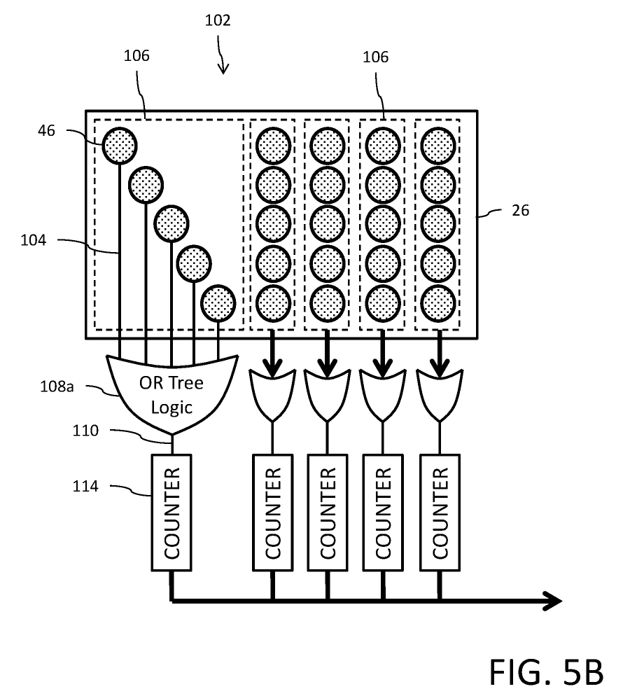

FIG. 5A shows a circuit diagram for the light intensity profile circuit 102. The circuit 102 is coupled to receive the photo signals 104 from the photosensitive pixels 46 of the sensor array 26. As noted above, the photosensitive pixels 46 are arranged in an array including a plurality of columns 106. The photo signals 104 from the photosensitive pixels 46 in each column are logically combined by a logic circuit (LC) 108 to generate a column detection signal 110 such that the output column detection signal 110 is asserted for each generation of the photo signal 104 by any photosensitive pixel 46 within the column 106. In an embodiment, the logical combination of the column photo signals 104 is performed by a logic OR tree 108a (see, FIG. 5B). In another embodiment, the logical combination of the column photo signals 104 is performed by an adder 108b (see, FIG. 5C). A counter circuit 114 is triggered to increment by one for each instance of the assertion of the column detection signal 110. Thus, in the instance where the photosensitive pixel 46 is a SPAD, the counter circuit 114 operates as a SPAD event counter with respect to the entire column of SPADs. The counter circuit 114 accordingly accumulates a column light intensity value corresponding to the number of times the photosensitive pixels 46 in the column generate a photo signal 104. The values in the counter circuits 114 thus produce a histogram indicative of the light intensity profile of the sensor array 26 in response to receipt of the reflected light signal 28. The column light intensity values are then output to the light scan position circuit 104 for processing as noted above.

In particular, the light scan position circuit 104 may operate to perform a peak detection operation on the histogram 120 in order to identify the particular column where the reflected light signal is received. A misalignment between the emitter and receiver is detected when the identified particular column differs from the anticipated or expected column given the maximum position of the transmit light signal with the scan. The degree of the misalignment is correlated to the number of columns offset between the identified particular column and the anticipated or expected column.

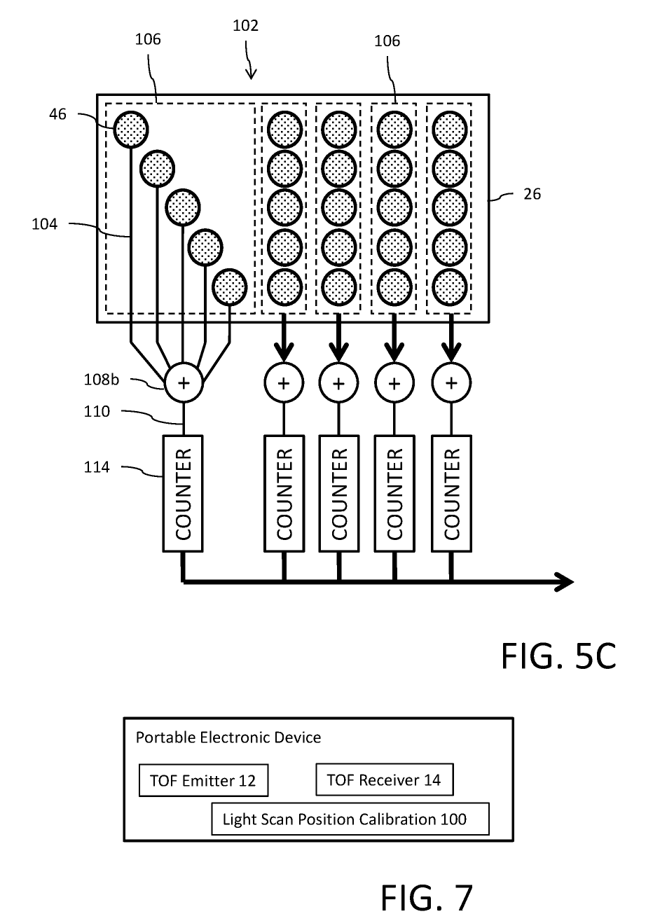

Operation of the light scan position calibration circuit 100 may be better understood through examination of an example operation in the context of FIG. 6. Assume that the scanning of the transmit light signal 18 is horizontal. As a consequence, the reflected light signal 28 will horizontally scan across the M columns of the sensor array 26. In an ideal situation, a left-most maximum of the horizontal scan of the transmit light signal 18 would produce a reflected light signal 28 received by the sensor array 26 at a corresponding left-most maximum of the M columns (for example, columns M=first).

With the optical misalignment, however, the left-most maximum of the horizontal scan of the transmit light signal 18 may produce a reflected light signal 28 received by the sensor array 26 at a column which is located other than at the left-most maximum of the M columns (for example, at a second column 44 of the SPADs 46 of the sensor array 26). The photosensitive pixels 46 of the entire sensor array 26 will detect the reflected light signal 28 as well as noise and generate photo signals 104. The logical combination circuit 108 for each column 106 will logically combine the photo signals 104 and assert the output column detection signal 110 for each photo signal 104. The counter 114 for each column 106 will count the number of times the output column detection signal 110 is asserted. The results of that counting operation across all columns 106 taken over an evaluation time period is shown by the histogram 120 which indicates a highest count value associate with the second column 106 of photosensitive pixels 46 within the sensor array 26. The light scan position circuit 104 can then interpret the histogram 120 information to conclude from the peak count (detection) information that there is about a one column to the right horizontal optical misalignment (offset). The photo signals within the image frame signal can then be processed in view of that detected magnitude of optical misalignment. Still further, if supported by the TOF system, an adjustment to the operation of the light scanning emitter 16 can be made to correct for the detected optical misalignment.

Although the example of FIG. 6 shows operation in the context of the left-most maximum of the horizontal scan of the transmit light signal 18, it will be understood that the same operation can be made with respect to the right-most maximum of the horizontal scan of the transmit light signal 18. Indeed, it is preferred that both the left-most and right-most operations be considered with respect to detecting the optical misalignment and the processing of image frame signal and/or the taking of adjustment or corrective actions.

It is also possible for the light scan position circuit 104, in the context of interpreting the histogram 120 information, to perform a linear interpolation in order to map the FOI for the horizontal scan of the transmit light signal 18 to the reception of the reflected light signal 28 by the columns of photosensitive pixels 46 within the sensor array 26. This linear interpolation will, for example, essentially map an illumination column to a corresponding reception column.

The timing of operation of the light scan position calibration circuit 100 may vary by application. In one example, the calibration operation to map an illumination column to a corresponding reception column may be performed once per imaging frame, or once every fixed number of imaging frames. Alternatively, the calibration operation to map an illumination column to a corresponding reception column may be performed at start-up of the TOF system. Still further, the calibration operation to map an illumination column to a corresponding reception column may be performed in response to a user command.

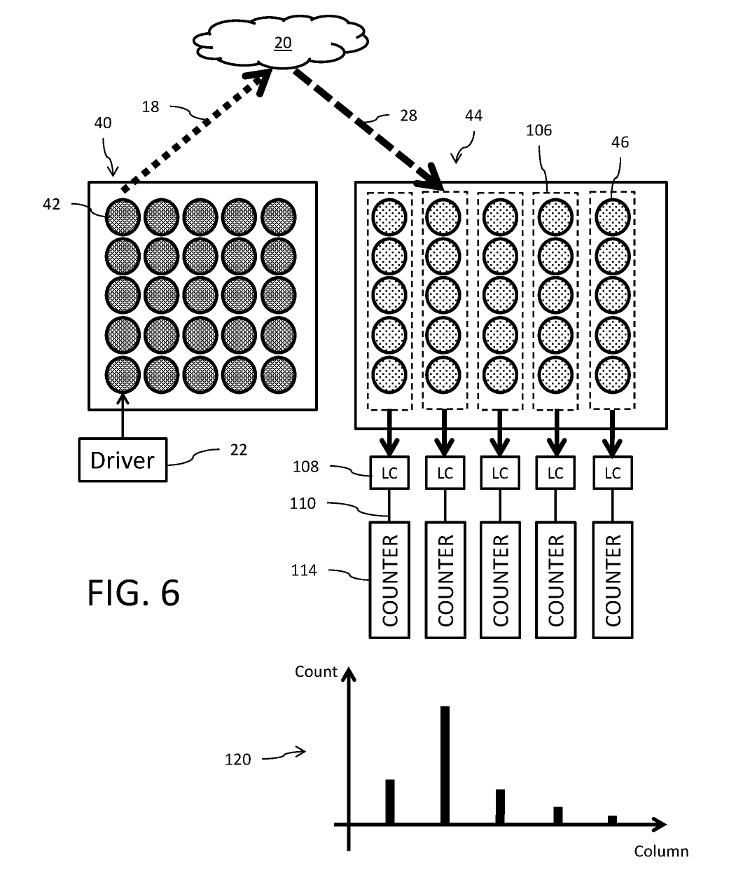

The TOF system components as shown in FIG. 4 may be incorporated within a portable electronics device, such as a cellular telephone or a camera, as shown in FIG. 7.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A circuit, comprising:
a sensor array including a plurality of columns, wherein each column includes a plurality of photosensitive pixels, each photosensitive pixel configured to generate a photo signal in response to light reception; and
a light intensity profile circuit coupled to the sensor array, the light intensity profile circuit comprising a counting circuit for each column storing a count value, wherein the counting circuit is configured to count over an evaluation time a number of times the photosensitive pixels in the column to which the counting circuit is coupled generate photo signals, the count values in the counting circuits after said evaluation providing a light profile histogram.

2. The circuit of claim 1, further comprising a scanning emitter configured to generate a transmit light signal towards a target, and wherein said light reception is from a reflected light signal generated by reflection of the transmit light signal off said target.

3. The circuit of claim 2, wherein the scanning emitter operates to scan the transmit light signal across said target, and wherein the light intensity profile circuit operates in a calibration mode in which the scanning emitter generates the transmit light signal at a first scan position and the light profile histogram indicates a column of said plurality of columns where the reflected light signal is received by the sensor array.

4. The circuit of claim 3, wherein the first scan position is a maximum position of the scan of the transmit light signal.

5. The circuit of claim 4, wherein the maximum position is one of a left-most or right-most scan position.

6. The circuit of claim 3, wherein in a calibration mode the scanning emitter further generates the transmit light signal at a second scan position and the light profile histogram indicates another column of said plurality of columns where the reflected light signal is received by the sensor array.

7. The circuit of claim 6, wherein the first and second scan positions are each a maximum position of the scan of the transmit light signal.

8. The circuit of claim 7, wherein the first scan position is a left-most maximum position of the scan and the second scan position is a right-most maximum position of the scan.

9. The circuit of claim 3, further comprising a processing circuit configured to process the light profile histogram and perform a peak detection on the count values to identify said column of said plurality of columns where the reflected light signal is received by the sensor array.

10. The circuit of claim 9, wherein the processing circuit is further configured to detect a misalignment condition if the identified column differs from an expected column for receiving the reflected light signal.

11. The circuit of claim 1, wherein the counting circuit for each column comprises:
a logic OR tree having inputs coupled to the photosensitive pixels in the column; and
a counter having an input coupled to an output of the logic OR tree.

12. The circuit of claim 1, wherein the counting circuit for each column comprises:
an adder having inputs coupled to the photosensitive pixels in the column; and
a counter having an input coupled to an output of the adder.

13. The circuit of claim 1, wherein the photosensitive pixels in the column to which the counting circuit is coupled are a subset of a total number of photosensitive pixels in the column.

14. The circuit of claim 1, further comprising a light scan position circuit configured to process the light profile histogram and detect an optical misalignment condition.

15. The circuit of claim 14, further comprising a scanning emitter configured to generate a transmit light signal towards a target, and wherein said light reception is from a reflected light signal generated by reflection of the transmit light signal off said target, and wherein the optical misalignment condition is a misalignment between the scanning emitter and the sensor array.

16. A method, comprising:
generating a transmit light signal at a first scan position;
receiving a reflection of said transmit light signal at a sensor array including a plurality of columns, wherein each column includes a plurality of photosensitive pixels;
generating by photosensitive pixels in said sensor array a photo signal in response reception of said reflection;
counting, over an evaluation time and for each column in the sensor array, a number of times the photosensitive pixels in the column generate photo signals; and
generating from said counting a light profile histogram.

17. The method of claim 16, further comprising processing said light profile histogram to detect an optical misalignment between a scanning emitter generating the transmit light signal and the sensor array.

18. The method of claim 17, wherein the light profile histogram indicates a column of said plurality of columns where the reflected light signal is received by the sensor array.

19. The method of claim 16, wherein the first scan position is a maximum position of a scanning of the transmit light signal over a target.

20. The method of claim 19, wherein the maximum position is one of a left-most or right-most scan position.

21. The method of claim 16, further comprising:
generating the transmit light signal at a second scan position;
wherein the light profile histogram indicates columns of said plurality of columns where the reflection of said transmit light signal at the first and second scan positions is received by the sensor array.

22. The method of claim 21, wherein the first and second scan positions are each a maximum position of a scanning of the transmit light signal over a target.

23. The method of claim 22, wherein the first scan position is a left-most maximum position of the scan and the second scan position is a right-most maximum position of the scan.

24. The method of claim 16, further comprising processing the light profile histogram by performing a peak detection of the counting to identify a column of said plurality of columns where the reflection of said transmit light signal is received by the sensor array.

25. The method of claim 24, wherein processing further comprises detecting a misalignment condition if the identified column differs from an expected column for receiving the reflection of said transmit light signal.

26. The method of claim 16, wherein the photosensitive pixels in the column whose photo signals are counted is a subset of a total number of photosensitive pixels in the column.

27. A circuit, comprising:
a scanning emitter configured to generate a transmit light signal at a first scan position;
a sensor array configured to receive a reflection of the transmit light signal, said sensor array including columns, wherein each column includes photosensitive pixels, the photosensitive pixels in the sensor array configured to generate a photo signal in response reception of the reflection of the transmit light signal;
a counting circuit configured, over an evaluation time and for each individual column in the sensor array, to count the number of times the photosensitive pixels in the column generate photo signals and product a light profile histogram from the column counts; and
a processing circuit configured to process the light profile histogram to detect an optical misalignment between the scanning emitter and the sensor array.
